(19) United States
(12) Patent Application Publication
(10) Pub. No.: US 2026/0077619 A1
(43) Pub. Date: Mar. 19, 2026

(54) WHEEL BEARING UNIT FOR A VEHICLE

(71) Applicant: Schaeffler Technologies AG & Co. KG, Herzogenaurach (DE)

(72) Inventors: Andreas Kaiser, Werneck (DE); Matthias Stahl, Schweinfurt (DE); Pavel Tseluyko, Schweinfurt (DE)

(73) Assignee: Schaeffler Technologies AG & Co. KG, Herzogenaurach (DE)

(21) Appl. No.: 19/108,728

(22) PCT Filed: Jun. 20, 2023
(86) PCT No.: PCT/DE2023/100465

§ 371 Date: Mar. 4, 2025

(30) Foreign Application Priority Data
Sep. 9, 2022 (DE) 10 2022 122 943.2

(51) Int. Cl. B60B 27/00

(52) U.S. Cl. CPC B60B 27/0078; B60B 2310/307

(57) ABSTRACT

The disclosure relates to a wheel bearing unit for a drive train of a motor vehicle, having: a wheel bearing hub with a first spur toothing, a joint cap of a drive joint with a second spur toothing, a non-round radially pretensionable element which is accommodated in a recess such that, in an elastically unstressed state, it protrudes at least partially from the recess in a radial direction, and an at least partially conical peripheral surface which, in an at least partially assembled state of the wheel bearing unit, is arranged opposite the radially pretensionable element in the radial direction. The radially pretensionable element and the at least partially conical peripheral surface interact during assembly of the wheel bearing unit in such a way that an axially acting force is generated, which braces the wheel bearing hub and the joint cap against one another.

### CROSS-REFERENCE TO RELATED APPLICATIONS

This application is the U.S. National Phase of PCT Application No. PCT/DE2023/100465 filed on Jun. 20, 2023, which claims priority to DE 10 2022 122 943.2 filed on Sep. 9, 2022, the entire disclosures of which are incorporated by reference herein.

### TECHNICAL FIELD

The present disclosure relates to a wheel bearing unit for a drive train of a vehicle, in particular a motor vehicle.

### BACKGROUND

Wheel bearing units for motor vehicles are known from the prior art in a variety of embodiments. In this regard, it is known to provide power transmission between a drive shaft and a wheel bearing hub via a radial or spur toothing. A spur toothing can be provided, for example, on a joint cap or a cardan shaft that engages with a drive shaft of the motor vehicle. The spur toothing of the joint cap can, in turn, engage with a correspondingly designed spur toothing of the wheel bearing hub so that a corresponding torque of the drive shaft can be transmitted to the wheel bearing hub.

The assembly of the wheel bearing unit is comparatively complex here, as the wheel bearing hub is usually first attached to a wheel carrier and then the joint cap is inserted into the wheel carrier, wherein the connection between the wheel bearing hub and the joint cap via the spur toothings is established in a blind assembly. As such, during the assembly of the joint cap and the wheel bearing hub, it can happen that the teeth of the spur toothing of the joint cap and the teeth of the spur toothing of the wheel bearing hub meet instead of meshing with one another. This means that the teeth of the spur toothing of the joint cap do not engage in the tooth gaps of the spur toothing of the wheel bearing hub. When the joint cap and the wheel bearing hub are braced in this so-called tooth-on-tooth position of the two spur toothings, the tooth heads of the two spur toothings are pressed onto one another and can only be brought into the so-called tooth-in-tooth position, in which the two spur toothings mesh, at a later point in time and using a comparatively large amount of force. This can lead to a loss of bias force in the joint cap/wheel bearing hub connection and/or damage to the spur toothings. In particular, to prevent a reduction in the bias force, various solutions are known in the prior art.

For example, DE 10 2007 057 047 A1 discloses a method for assembling a wheel hub component with a shaft joint component connected thereto in a rotationally fixed manner, and a corresponding connection arrangement. In the prior art, snap rings are used to connect the joint cap and the wheel hub and to avoid tooth-on-tooth positions in spur toothing, which pulls both components together in a tooth-in-tooth position. These snap rings are usually round.

It has now become apparent that there is a further need to improve a known wheel bearing unit for a vehicle, in particular to provide a spur toothed wheel bearing unit which is not only easier to assemble, but which can ensure a secure connection between the ball joint and the wheel hub, which is also cost-effective. A tooth-on-tooth position of the spur toothing should also be avoided.

### SUMMARY

Against this background, it is an object of the present disclosure to provide an improved wheel bearing unit for a vehicle which can be assembled more easily, which ensures a secure connection between the joint cap and the wheel hub and which is cost-effective.

This and other objects that could be mentioned or recognized by a person skilled in the art upon reading the following description are achieved by the subject matters of the independent claims. Advantageous embodiments and further developments can be found in the dependent claims and the following description.

A wheel bearing unit according to the disclosure for a drive train of a vehicle, in particular a motor vehicle, has a wheel bearing hub with a first spur toothing, a joint cap of a drive joint with a second spur toothing, a circumferential, radially pretensionable element and an at least partially conically formed peripheral surface. The radially pretensionable element is accommodated in a circumferential recess in such a way that, in an elastically unstressed state, it protrudes at least partially from the recess in the radial direction and also protrudes at least partially into the recess. In an at least partially assembled state of the wheel bearing unit, the conical peripheral surface is arranged opposite the radially pretensionable element in the radial direction. Here, the radially pretensionable element and the conical peripheral surface interact during assembly of the wheel bearing unit in such a way that an axially acting force is generated, which braces or biases the wheel bearing hub and the joint cap against one another. The radially pretensionable element is non-round.

The non-round shape of the radially pretensionable element is understood to mean a shape deviating from a circle. Due to the non-round shape of the radially pretensionable element, the element does not lie on the circumferential surface over its entire outer surface, but only at certain contact points.

The radially pretensionable, circumferential element can in particular be designed as ring-shaped, star-shaped or slotted when closed, i.e., as ring-shaped or star-shaped when open. Furthermore, the radially pretensionable, circumferential element can also be designed as oval, drop-shaped, etc., wherein the radially pretensionable element can also be designed as closed or slotted, i.e., open, in these shapes. In particular, a star-shaped and/or open radially pretensionable, circumferential element enables improved guidance in the recess and/or enables greater radial spreading. For example, the radially pretensionable element can be designed as a rubber ring, such as an O-ring. In addition, the radially pretensionable, circumferential element can, for example, be designed as a circlip, which can be made of a plastic or plastic mixture, or a metal or a metal alloy. The axially acting force can also be referred to as the axial bias force.

The advantage of the solution according to the disclosure lies in particular in the fact that the contact of the radially pretensionable element with the conical peripheral surface generates a radial force due to the elastically stressed state of the radially pretensionable element, which, in conjunction with the conical peripheral surface, generates an axially acting force in the assembly direction, thus bracing the wheel bearing hub and the joint cap against one another. This means that the wheel bearing hub and the joint cap cannot easily fall apart during assembly of the wheel bearing unit, even if the first and second spur toothing are in a tooth-on-tooth position. In this state, a tooth-in-tooth position of the first and second spur toothing can be achieved by a small rotational relative movement between the wheel bearing hub and the joint cap. Due to the axially acting force, the wheel bearing hub and the joint cap are then held in the tooth-in-tooth position, in which they can then be firmly braced together by means of a bracing element, for example a clamping screw.

Snapping the elastically pretensionable element into the conical peripheral surface can also make it less likely for the connection to become detached, as the elastically pretensionable element must be elastically deformed in a direction opposite to the assembly direction against the radial force, which can only be achieved by applying an external force.

In other words, a wheel bearing unit with a biased snap-in device is proposed in order to produce a tooth-in-tooth assembly between the first spur toothing of the wheel bearing hub and the second spur toothing of the joint cap. Furthermore, such a snap-in device requires hardly any additional installation space, which is why the installation space requirement of the wheel bearing unit remains essentially unchanged.

According to one embodiment of the wheel bearing unit, the radially pretensionable element has a plurality of contact points which rest on the circumferential surface. The outer surface of the pretensionable element between these contact points does not rest on the peripheral surface. This creates an additional spring force between the contact points, which results in the overall spring force of the pretensionable element being increased in the radial direction. This effect even makes it possible to reduce the cross-section of the pretensionable element without sacrificing radial spring force. This has the advantage of cost savings and downsizing. Due to the increased radial spring force of the radial pretensionable element according to the disclosure, a more secure connection between the joint cap and the wheel hub can be achieved without increasing the costs.

According to a further embodiment of the wheel bearing unit, the radially pretensionable element has three contact points which rest on the circumferential surface. These three contact points can be arranged at an angle of substantially 120° to each other so that they are evenly distributed over the circumference of the pretensionable element. This arrangement results in optimal spring surfaces between the contact points, so that the radial spring force is optimally increased.

However, it would also be conceivable that a different arrangement of the contact points could be provided, distributed over the circumference. For example, it would also be conceivable to provide only two contact points, which are arranged opposite one another, for example. However, the provision of four or more contact points arranged symmetrically or asymmetrically over the circumference of the pretensionable element would also be conceivable.

According to an example embodiment of the wheel bearing unit, the radially pretensionable element has an opening which extends in particular over an angle between 10° and 45°. The opening in this area refers to the non-assembled or non-biased state of the element.

The opening allows the pretensionable element to spring and snap into the recess without reducing the radially acting spring force.

In an example embodiment, the radially pretensionable element of the wheel bearing unit has at least two, in particular three windings. The pretensionable element is wound several times, similar to a spring. Through these at least two windings, the radial spring force can be further increased. This design allows the cross-section of the pretensionable element to be reduced without reducing the radially acting spring force.

According to an example embodiment of the wheel bearing unit, the radially pretensionable element has an outer diameter which is larger than the sum of its inner diameter and three times the cross-section diameter or thickness of the radially pretensionable element.

In an example embodiment, the radially pretensionable element is constructed of a spring steel or a plastic. These materials have optimal spring properties so that a good radial spring force can be generated.

According to a further embodiment of the wheel bearing unit, the radially pretensionable element has a substantially round cross-section. This design allows the pretensionable element to snap into a correspondingly designed recess.

The radially pretensionable element can be mounted in the recess without play. The radially pretensionable element can center the joint cap and wheel hub relative to each other.

Advantageously, the recess is provided on an outside diameter of the joint cap and the conical peripheral surface is provided on an inside diameter of the wheel bearing hub, wherein the inside diameter of the wheel bearing hub is larger than the outside diameter of the joint cap. Due to the recess on the outside diameter of the joint cap, the radially pretensionable element is easy to assemble and can be designed in particular as a circlip. Alternatively, according to a further embodiment, the recess is provided on an inside diameter of the wheel bearing hub and the conical peripheral surface is provided on an outside diameter of the joint cap, wherein the inside diameter of the wheel bearing hub is larger than the outside diameter of the joint cap. The recess on the inside diameter of the wheel bearing hub further allows the use of an inexpensive O-ring as the radially pretensionable element.

### BRIEF DESCRIPTION OF THE DRAWINGS

Further measures improving the disclosure are illustrated below together with the description of exemplary embodiments of the disclosure using the figures. In the drawings:

FIG. 1A shows a schematic partial representation of a wheel bearing arrangement according to one embodiment of the disclosure;

FIG. 1B shows a perspective view of a radially pretensionable element according to the prior art; and

FIG. 2 shows a radially pretensionable element according to one embodiment of the disclosure.

### DETAILED DESCRIPTION

The figures are only schematic in nature and serve only for understanding of the disclosure. Identical elements are provided with the same reference signs.

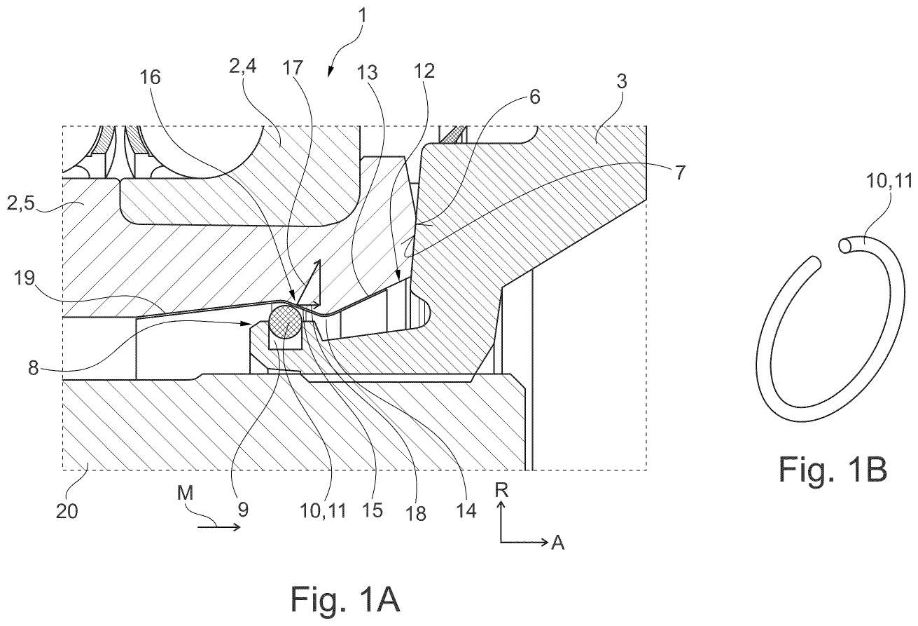

FIG. 1A shows an exemplary, schematic partial representation of a wheel bearing unit 1 according to the disclosure for a vehicle, having a wheel bearing 2 and a joint cap 3 in a longitudinal section. The wheel bearing 2 has a rolling bearing 4 and a wheel bearing hub 5, on which the rolling bearing 4 is arranged in an axially fixed manner. The wheel bearing hub 5 further has a first spur toothing 6, which is in torque-transmitting engagement with a second spur toothing 7 on the joint cap 3 in an assembled state of the wheel bearing unit 1.

In FIG. 1A, the joint cap 3 further has a recess 9 on an outside diameter 8, in which a radially pretensionable element 10 is arranged in such a way that, in an elastically unstressed state, it protrudes at least partially outwards from the recess 9 in the radial direction R. In this regard, the recess 9 is designed in such a way that it can essentially completely accommodate a volume of the radially pretensionable element 10 in an elastically stressed state.

The radially pretensionable element 10 is made in particular from a plastic, a plastic mixture, a metal or a metal alloy and is advantageously designed as a snap ring 11. The wheel bearing hub 5 has a guide surface 13, a constriction diameter 14 and a conical peripheral surface 15 on an inner side 12, wherein the constriction diameter 14 is smaller than the guide surface 13 of the wheel bearing hub 5, but larger than the outside diameter 8 of the joint cap 3.

The guide surface 13 is formed in an inclined, in particular conical, manner such that the radially pretensionable element slides along the guide surface 13 when the joint cap 3 is inserted into the wheel bearing hub 5 and is thus gradually elastically compressed. The gradual elastic compression of the radially pretensionable element 10 makes it easier to guide it through the constriction diameter 14. After passing the constriction diameter 14, the radially pretensionable element 10 expands outwards again in the radial direction until it comes into contact with the conical peripheral surface 15. Here, the conical peripheral surface 15 is designed in such a way that the cone tapers in the axial direction A towards the constriction diameter 14. This means that the radially pretensionable element 10 cannot transition to an elastically unstressed state after passing the constriction diameter 14, as a result of which a radial force 17 is generated in a contact region 16 between the radially pretensionable element 10 and the conical peripheral surface 15, which acts on the conical peripheral surface 15. Due to the conical, i.e., oblique in the longitudinal section, course of the conical peripheral surface 15, the radial force 17 acting perpendicularly on the conical peripheral surface 15 results in an axial force 18 acting in the axial direction A, which braces the wheel bearing hub 5 and the joint cap 3 minimally or slightly against one another in an assembly direction M. The axial force 18 can also be referred to as the axial bias force 18.

In this regard, the constriction diameter 14 and the conical peripheral surface 15 are arranged in the axial direction A in such a way that the radially pretensionable element 10 is already “snapped in”, so to speak, behind the constriction diameter 14 when the spur toothings 6, 7 are in a tooth-on-tooth position, and the axial force 18 is thus already generated. The axial force 18 causes the wheel bearing hub 5 and the joint cap 3 to be braced against one another in the tooth-on-tooth position during the assembly of the wheel bearing unit 1 in such a way that the joint cap 3 does not fall out of the wheel bearing hub 5 again. A tooth-in-tooth position, which can also be referred to as a tooth-in-gap position, can be produced by a rotational relative movement between the wheel bearing hub 5 and the joint cap 3, wherein the axial force 18 is designed to axially bias the wheel bearing hub 5 and the joint cap 3 against one another also in the tooth-in-tooth position, thus preventing the joint cap 3 from falling out of the wheel bearing hub 5 also in the tooth-in-tooth position.

Furthermore, the wheel bearing hub 5 has a trailing surface 19 which is arranged downstream of the conical peripheral surface 15 as viewed in the assembly direction M. The trailing surface 19 can either be formed as oppositely conical (see FIG. 1A) with respect to the conical peripheral surface 15 or substantially cylindrical. The trailing surface 19 is used to accommodate the radially pretensionable element 10 after the assembly of the wheel bearing unit 1, in particular after the wheel bearing hub 5 and the joint cap 3 have been braced by a bracing element 20, such as a clamping screw, and thus prevent the radially pretensionable element 10 from slipping out of the recess 9. In particular, the oppositely conically shaped trailing surface 19 can elastically stress or elastically compress the radially pretensionable element 10 in such a way that the radially pretensionable element 10 is braced in the recess in such a way that it is essentially unable to move in the operating state of the wheel bearing unit 1. The substantially cylindrically designed trailing surface 19 prevents the radially pretensionable element 10 from slipping out of the recess 9, but the radially pretensionable element 10 can move between the cylindrical trailing surface 19 and the recess 9 and thus cause rattling in the operating state of the wheel bearing unit 1.

In FIG. 1A, the recess 9 is integrally formed in one piece on the outside diameter 8 of the joint cap 3 by way of example, wherein the recess is formed as a groove 21. Alternatively, the recess 19 could also be designed as a groove. Both are easy and inexpensive to produce.

In an example embodiment, the peripheral surface 15 can be designed such that the wheel bearing hub 5 and the joint cap 3 are pressed apart in a tooth-on-tooth position. In this way, the installer can recognize that there is a faulty assembly and can take corrective action. Therefore, the radially pretensionable element 10 does not snap over the constriction diameter 14 in a tooth-on-tooth position. In a tooth-in-tooth position, the radially pretensionable element 10 can snap over the constriction diameter 14 and pulls the joint cap 3 and the wheel bearing hub 5 together. This enables a haptic assembly control for the installer.

FIG. 1B shows a radially pretensionable element 10 according to the prior art. The radially pretensionable element 10 is in particular round and open on one side to allow compression into the recess 9. Due to its round design, the radially pretensionable element 10, which is designed in particular as a snap ring 11, rests on the peripheral surface 15 over its entire outer circumference. Here only a small radial force 17 is generated.

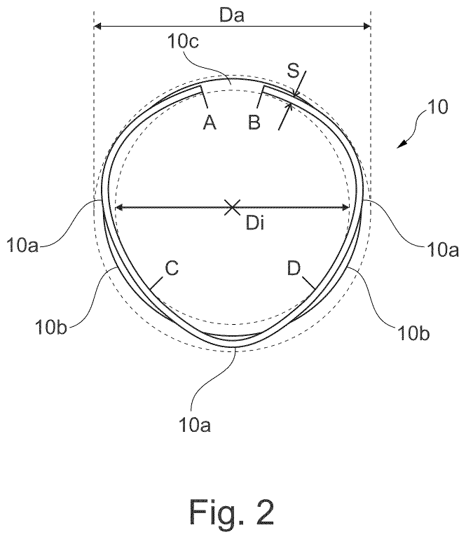

FIG. 2 shows a radially pretensionable element 10 according to one embodiment of the disclosure. The radially pretensionable element 10 can be designed as a snap ring 11 which is open on one side. The radially pretensionable element 10 is non-round, i.e., has a shape deviating from a circle. The element 10 can have a plurality of contact points 10a which, in the mounted state, come into contact with the peripheral surface 15 in the recess 9. As a result, spring surfaces 10b are formed between the contact points 10a, which generate a significant increase in the radial force 17 when the pretensionable element 10 is mounted. The change in the shape of the pretensionable element 10 enables an increased radial force 17, and thus a significantly safer connection between the wheel bearing hub 5 and the joint cap. The pretensionable element 10 is mounted free of play and centered in the recess 9. The pretensionable element 10 can be centered on the inner surface via at least two, or, in an example embodiment, four contact points A, B, C, D. Tilting of the pretensionable element 10 is prevented.

In example embodiment, the pretensionable element 10 has three external contact points 10a and, in a further aspect, four internal contacts A, B, C, D. In an example embodiment, the pretensionable element 10 has an odd number of contact points 10a, which can be evenly distributed over the circumference. The pretensionable element 10 has an opening 10c which extends in particular over an angle of 10°-45°, or, in an example embodiment, up to 30°. Furthermore, the outer diameter Da of the radially pretensionable element 10 is larger than the sum of its inner diameter Di and three times the cross-section diameter or thickness(s) (Da>Di 3*s).

### LIST OF REFERENCE SYMBOLS

1 Wheel bearing unit
2 Wheel bearing
3 Joint cap
4 Rolling bearing
5 Wheel bearing hub
6 First spur toothing
7 Second spur toothing
8 Outside diameter
9 Depression
10 Radially pretensionable element
10a Contact points
10b Spring surfaces
10c Opening
11 Circlip
12 Inner side
13 Guide surface
14 Constriction diameter
15 Conical peripheral surface
16 Contact region
17 Radial force
18 Axial force
19 Trailing surface
20 Bracing element
Da Outside diameter
Di Inside diameter
S Cross-section
A, B, C, D Contacts

1. A wheel bearing unit for a drive train of a motor vehicle, comprising:
a wheel bearing hub having:
a first spur toothing,
a joint cap of a drive joint with a second spur toothing,
a radially pretensionable element which is accommodated in a recess such that, in an elastically unstressed state, it protrudes at least partially from the recess in a radial direction, and
an at least partially conical peripheral surface which, in an at least partially assembled state of the wheel bearing unit, is arranged opposite the radially pretensionable element in the radial direction (R), and
the radially pretensionable element and the at least partially conical peripheral surface cooperate during assembly of the wheel bearing unit such that an axially acting force is generated, which braces the wheel bearing hub and the joint cap against one another, and
the radially pretensionable element is non-round.

2. The wheel bearing unit according to claim 1, wherein the radially pretensionable element has a plurality of contact points which rest on the at least partially conical peripheral surface.

3. The wheel bearing unit according to claim 1, wherein the radially pretensionable element has three contact points which rest on the at least partially conical peripheral surface.

4. The wheel bearing unit according to claim 2, wherein the three contact points are evenly distributed over the circumference of the at least partially conical peripheral surface, such that an angle of 120° is provided between the contact points.

5. The wheel bearing unit according to claim 2, wherein the radially pretensionable element has an opening which extends in over an angle between 10° and 45°.

6. The wheel bearing unit according to claim 2, characterized in that the radially pretensionable element has at least two windings.

7. The wheel bearing unit according to claim 5, wherein an outer diameter of the radially pretensionable element is larger than a sum of: i) an inner diameter of the radially pretensionable element, and ii) three times a diameter of a cross-section of the radially pretensionable element.

8. The wheel bearing unit according to claim 7, wherein the radially pretensionable element is constructed of a spring steel or a plastic.

9. The wheel bearing unit according to claim 5, wherein the radially pretensionable element has a substantially round cross-section.

10. The wheel bearing unit according to claim 2, wherein the recess is formed in the joint cap.

11. A wheel bearing unit for a drive train of a motor vehicle, comprising:
a wheel bearing hub having:
a first spur toothing,
a joint cap of a drive joint with a second spur toothing meshed with the first spur toothing,
a non-round radially pretensionable element disposed in a recess,
an inclined guide surface configured to compress the non-round radially pretensionable element within the recess during assembly of the joint cap to the wheel bearing hub, and
a conical peripheral surface arranged radially outwardly of the non-round radially pretensionable element such that the non-round radially pretensionable element presses on the conical peripheral surface so as to generate an axial bias force configured to brace the first spur toothing and the second spur toothing against one another.

12. The wheel bearing unit of claim 11, wherein the inclined guide surface is formed as oppositely conical with respect to the conical peripheral surface.

13. The wheel bearing unit of claim 12, wherein the inclined guide surface is axially adjacent to and adjoined with the conical peripheral surface.

14. The wheel bearing unit of claim 13, wherein the inclined guide surface and the conical peripheral surface are formed on a radial inner surface of the wheel bearing bearing hub.

15. The wheel bearing unit of claim 14, wherein the recess is formed on the joint cap.

16. The wheel bearing unit of claim 15, wherein the non-round radially pretensionable element has a plurality of contacts which rest on the conical peripheral surface.

17. The wheel bearing unit of claim 15, further comprising an inclined trailing surface:
adjoined to the conical peripheral surface, and
formed as oppositely conical with respect to the conical peripheral surface.

18. The wheel bearing unit of claim 17, wherein the inclined trailing surface is arranged downstream of the conical peripheral surface in an axial assembly direction.

19. A wheel bearing unit for a drive train of a motor vehicle, comprising:
a wheel bearing hub having:
a first spur toothing,
a joint cap of a drive joint having:
a second spur toothing meshed with the first spur toothing, and
a radial groove,
a non-round radially pretensionable element disposed in the radial groove, and
an inner surface of the wheel bearing hub is configured to slidably receive the non-round radially pretensionable element, the inner surface having:
an inclined guide surface, and
a conical peripheral surface adjoined with the inclined guide surface, and
when the joint cap is assembled with the wheel bearing hub in an axial assembly direction, the non-round radially pretensionable element is radially compressed via the inclined guide surface and then radially expanded via the conical peripheral surface located downstream of the inclined guide surface in the axial assembly direction.

20. The wheel bearing unit according to claim 19, wherein the non-round radially pretensionable element has a plurality of circumferentially spaced contact points which rest on the conical peripheral surface.
